(19) United States
(12) Patent Application Publication
(10) Pub. No.: US 2011/0199489 A1
(43) Pub. Date: Aug. 18, 2011

(54) METHOD FOR THE EXTRACTION OF AN IR-IMAGE AND THERMAL IMAGING CAMERA

(75) Inventors: Jörn Fischer, Freiburg (DE); Matthias Schmieder, Freiburg (DE); Martin Stratmann, Freiburg (DE); Markus Appenzeller, Freiburg (DE)

(73) Assignee: Testo AG, Lenzkirch (DE)

(21) Appl. No.: 13/029,438

(22) Filed: Feb. 17, 2011

(30) Foreign Application Priority Data
Feb. 18, 2010 (DE) 102010008456.5-31

(51) Int. Cl. H04N 5/33; G06K 9/00

(52) U.S. Cl. 348/164; 382/168; 348/E05.09

(57) ABSTRACT

A thermal imaging camera (1) which, in order to extract IR-images (2) from a stream of crude data (12) of crude IR-images (3), performs a compensation (21) of pixel measurements (6) of the crude IR-images (3) with pixel-background values (8) pixel by pixel, with a new calculation (19) of the pixel-background value (8) being performed when the variation of the pixel measurements (6) in the measurement sequence of the crude data stream (12) for the pixels exceeds a lower limit for variations.

### CROSS-REFERENCE TO RELATED APPLICATIONS

This application claims the benefit of German Patent Application No. 10 2010 008 456.5, filed Feb. 18, 2010, which is incorporated herein by reference as if fully set forth.

### BACKGROUND

The invention relates to a method for the extraction of an IR-image from a sequence of crude IR-images, which were recorded with an IR-sensor arrangement and comprise pixels with pixel measurements, with a pixel-background value being provided for each pixel of the crude IR-images and with the IR-image being extracted from a sequence of crude IR-images by the pixel-background value being compensated pixel by pixel with the pixel measurements of at least one crude IR-image of the sequence.

The invention further relates to a thermal imaging camera.

It is known to equip thermal imaging cameras with a shutter, by which the radiation path of an IR-sensor arrangement can be closed. Thus, with the shutter closed a measurement can be detected from each pixel of the IR-sensor arrangement, which is used as the pixel-background value (so-called offset), by which the pixel measurements of the pixels are compensated when the shutter is open. Due to the fact that the pixel-background value changes slightly over time, it is necessary to close the shutter in regular intervals, typically once every 20-60 seconds, and to determine a new pixel-background value. During these off-times, the thermal imaging camera is therefore blind, which is of a particularly disturbing effect when video sequences are recorded. Additionally, when in such a video sequence sound is recorded, the closing shutter also causes a disturbing closing noise on the sound track.

In order to perform the non uniformity correction of the crude IR images recorded, necessary in thermal imaging cameras without any shutter, a scene-based method was developed, which uses a Kalman-filter with temporarily random means or neuronal networks, in which the error is minimized between an averaged pixel value and averaged pixel values of adjacent pixels. Usually, considerable calculating capacity is required for the implementation of this method, which aggravates the use of thermal imaging cameras.

### SUMMARY

The invention is based on the objective of providing a method for extracting an IR-image, which can be integrated in a thermal imaging camera with little expense.

In order to attain this, a method of the type mentioned at the outset comprises that a measurement sequence of pixel measurements of the pixel in the sequence of crude IR-images is evaluated for at least one pixel and that the pixel-background value underlying said pixel is changed when the deviation of the pixel measurement in the measurement sequence exceeds or does not fall below a predetermined lower limit. Therefore, the invention uses the knowledge that the pixel measurements always vary by a value in randomly changing scenes, which is specific for each pixel (sensor-element specific) and thus it can be used as the pixel background. Due to the restriction to pixel measurements varying stronger than predetermined by the lower limit the ratios of randomly changing scenes are simulated in a simple fashion. The invention offers the advantage that the program routines required for implementing the methods are simple and require only a small calculating capacity. Additionally, the invention eliminates the need for a shutter, so that blind periods are avoided. This way, the method can be used for reliably following a target or monitoring. Another advantage of the invention is the fact that disturbing side noises of a shutter can be avoided.

It may be provided that the pixel-background value of a pixel is calculated from the measurement sequence of the pixel. It is beneficial if each pixel value contributes to a certain pixel depending on its change from the previous pixel value of the measurement sequence to determine the pixel background value of the pixel. Here, the amount may be small when the change is minor, and large when the change is major.

In order to avoid a drift of the calculated pixel-background value due to accidentally constant pixel values it may be provided that for the calculation of the pixel-background value only such pixel measurements of the measurement sequence are considered if their deviation, particularly their difference from the respectively previous pixel measurement of the measurement sequence, exceeds or does not fall below a predetermined lower limit. This way it can be easily achieved that only such pixel measurements are considered for the calculation of the pixel-background value that are disbursed around an average. Here it is advantageous that pixels that remain unchanged can be excluded from the calculation in order to avoid that stationary scenes burn into the pixel background.

In order to prevent faulty pixel-background values it may additionally be provided that for the calculation of the pixel-background values such pixel values are not considered, if their deviations particularly their difference to the respectively previous pixel measurement of the measurement sequence, exceed or fails to fall below a predetermined upper limit. Here it is advantageous that any shift of the pixel-background values by sudden, strong, actual changes of the scenery, major temperature shifts, and the like can be avoided. Such temperature shifts or strong changes of pixel-values are therefore filtered out. This way, even major changes in scenery can be shown and it can be avoided that outliers with major deviations from the average can be burned in.

In order to detect high-temperature portions and to exclude them from the calculation of the pixel-background value or to reduce their influence on the calculation of the pixel-background values it may also be provided for the overall average to influence the calculation of the pixel-background value via the pixel values of all pixels. The overall average of the pixels of a crude IR-image is a useful guideline to detect high-temperature portions and other outliers which shall not contribute to the pixel-background value.

It may be provided that for the calculation of the pixel-background value an average, particularly arithmetic, weighted, or lagging average or an expected value is calculated from the pixel measurements of a measurement sequence. The use of lagging or weighted averages is advantageous in that actual off-set changes can be better considered.

Alternatively it may be provided that, in order to calculate the pixel-background value, an upper limit and/or a lower limit is/are determined for pixel measurements of the measurement sequence. Preferably the upper limit and/or the lower limit are calculated in a weighted fashion. This way, the pixel-background value can be calculated from averaging the upper and lower limit. It has shown that frequently the average of the limits is very similar to the average of pixel measurements of a measurement sequence.

In order to yield good IR-images as soon as possible after the device is activated it may be provided that for each pixel-background value an initial value is provided. Here, it is advantageous that a transient oscillating behavior for useful pixel-background values can be shortened. For example, for this purpose initial values may be predetermined by the manufacturer or the most recently calculated pixel-background values may be saved in a storage unit.

The image quality can be further improved when for the calculation of the pixel-background value of a pixel at least one adjacent pixel is considered, preferably compensated with its allocated pixel-background value. This way it can be utilized that adjacent pixels usually contain sections of scenes of similar temperature and thus must show similar or equal pixel values after the compensation with the pixel-background value. This has a particularly beneficial effect in crude IR images of moving scenes. Preferably all adjacent pixels are considered, here.

For example, it may be provided that pixel measurements with different weights are used for the calculation of the pixel-background value of a pixel, preferably compensated with their corresponding pixel-background values of pixels adjacent in the vertical direction and in the horizontal direction. This way it can be considered that the size of the pixel value of a vertical neighbor or a horizontal neighbor can play a different role for weighing the influence of neighboring pixels. The weights can be determined for the production of the thermal imaging camera and be saved for later use.

The image quality after compensation can be further improved by determining a movement of image contents within an image sequence using a local motion detector, with the direction and/or the speed of the motion being considered in the calculation of the pixel-background value. This way, an object can be shown with a temperature constant over time, which is expected in the IR-images at different image positions, in the extracted IR-images showing homogenous or nearly constant temperature information, by appropriately adjusting the pixel-background values.

Here, the motion detection can be performed via image processing software by comparing the crude IR-images or the IR-images with each other or it may be provided that the motion detection is performed by an acceleration sensor.

In order to avoid stationary images it may be provided that the IR-sensor arrangement and/or an element arranged in a radiation path of the IR-sensor arrangement is moved when the measurement sequences of the pixels show insufficient variations.

Preferably the method according to the invention is constantly repeated in order to create an IR-video data-stream of IR-images.

Absolute temperature values can be deduced from the extracted IR-image when a temperature sensor is provided and read, with the temperature measurements allowing an allocation of the pixel-background values to absolute temperature values.

In order to attain the objective, the invention provides for a thermal imaging camera with an IR-sensor arrangement, which is set to record crude IR-images and comprises an output unit for displaying an IR-image extracted from the recorded crude IR-images, and for a data processing unit to be embodied, which is arranged, particularly programmed, to perform the method according to the invention.

For this purpose, the thermal imaging camera may be embodied as a hand-held or a mobile device, preferably having an integrated energy supply.

### BRIEF DESCRIPTION OF THE DRAWINGS

In the following, the invention is explained in greater detail using an exemplary embodiment, however it is not limited to said exemplary embodiment. Additional exemplary embodiments result from combining one or more features of the claims with each other and/or with one or more features of the exemplary embodiment.

Shown in a partially schematic illustration

FIG. 1 is a view of a thermal imaging camera according to the invention from the rear,

FIG. 2 is a front view of the thermal imaging camera according to FIG. 1,

FIG. 3 is a block diagram of components of the thermal imaging camera according to FIG. 1, cooperating in a method according to the invention,

FIG. 4 is a structure chart of a method according to the invention,

FIG. 5 shows an example of pixel values in a crude IR-image in a method according to the invention as shown in FIG. 4,

FIG. 6 shows an example of pixel-background values for an image sequence of crude IR-images in a method according to the invention as shown in FIG. 4, and

FIG. 7 shows the IR-image calculated from FIGS. 5 and 6.

### DETAILED DESCRIPTION OF THE PREFERRED EMBODIMENTS

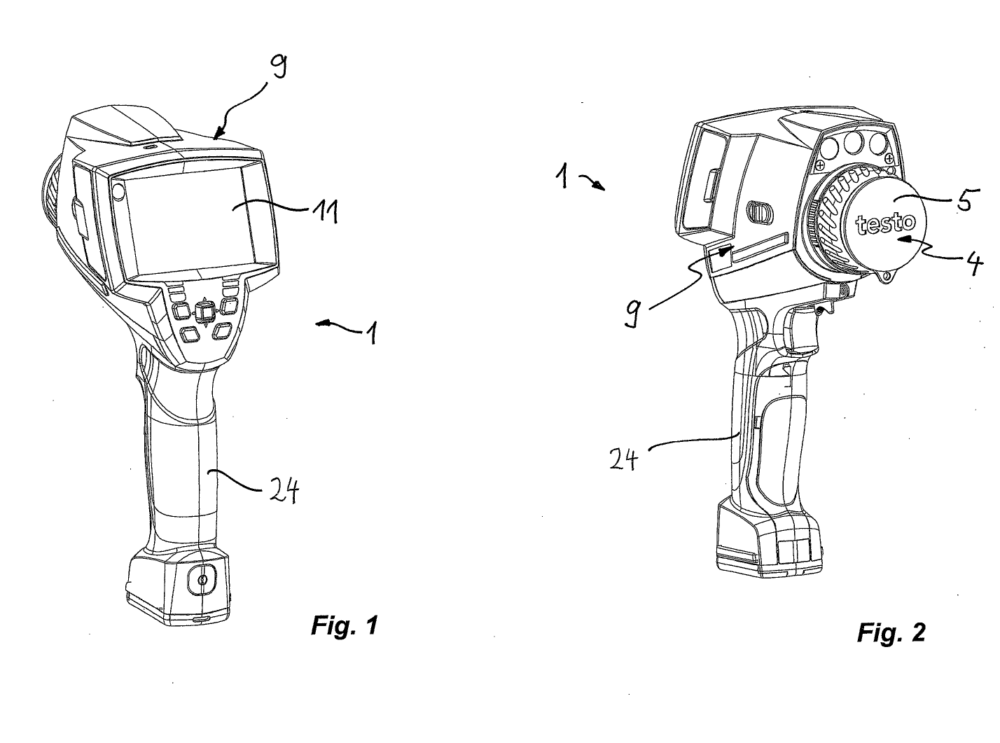

FIGS. 1 and 2 show a thermal imaging camera marked 1 in its entirety, which is embodied to perform the method according to the invention.

As explained in greater detail in the following, using the method according to the invention an IR-image 2 shown for example in FIG. 7 can be extracted from an image sequence of crude IR-images 3 shown exemplarily in FIG. 5 without requiring a shutter commonly necessary in cameras for thermal imaging.

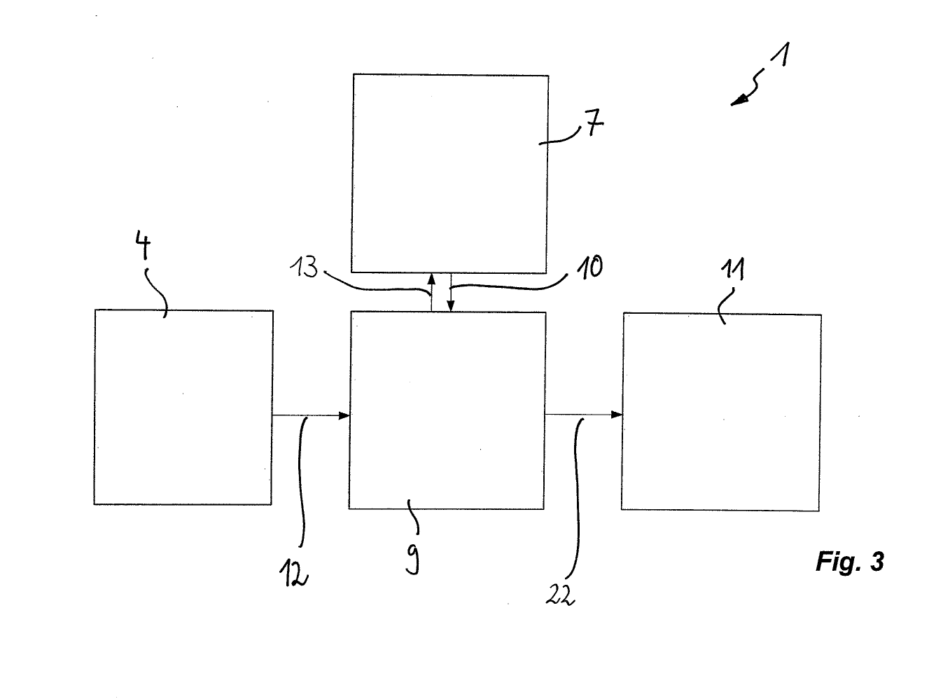

In order to record the crude IR-images 3 the thermal imaging camera 1 comprises, as discernible from the block diagram according to FIG. 3, an IR-sensor arrangement 4, which is arranged behind an IR-optic 5 (cf. FIG. 2).

In the exemplary embodiment, the IR-sensor arrangement 4 comprises a grid-shaped arrangement of micro-bolometers. This arrangement comprises considerably more micro-bolometers than shown in FIGS. 5 through 7 to illustrate the principle of the invention.

The IR-sensor arrangement 4 therefore provides crude IR-images 3, which are filled with pixel measurements 6.

Due to the fact that these pixel measurements 6 are considerably influenced by the individual embodiment of the IR-detector element allocated to the pixel, pixel-background values 8 are provided in a storage device 7 of the thermal imaging camera 1 (cf. FIG. 3). A data processing device 9 with a processor and/or a logic that can be configured (for example FPGA) can read the saved pixel-background values 8 in a reading process 10 and compensate them with the pixel measurements 6 of the crude IR-images 3.

In the simplest case, the pixel-background value 8 is subtracted pixel by pixel from the pixel measurement.

From the compensation an extracted IR-image 2 results, which is released and/or displayed by an output unit 11, for example a display or a data interface.

The invention now provides for the data processing unit 9 to be programmed such that adjusted pixel-background values 8 can be calculated from the crude data stream 12 created by the IR-sensor arrangement 4, which are stored via a writing process 13 in the storage device 7 for future use, particularly for compensations.

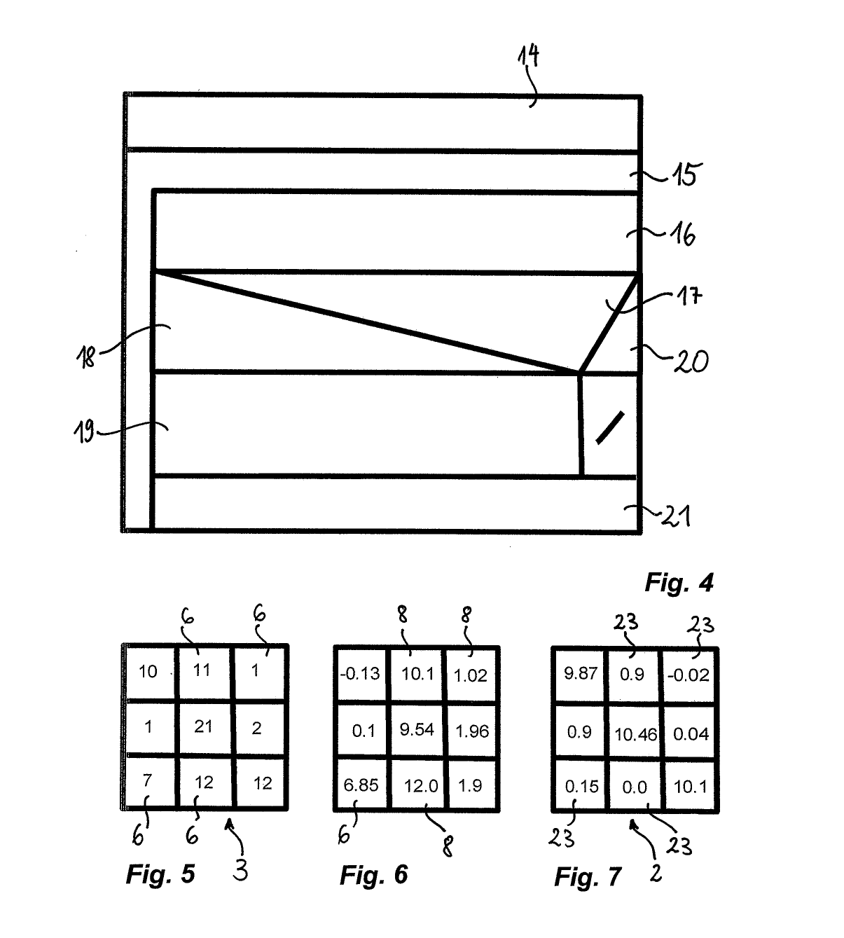

In order to achieve that for the pixels of the crude IR-image 3 a measurement sequence of pixel measurements 6 in the image sequence of the data stream 12 is evaluated and the corresponding pixel-background value 8 saved in the storage device 7 is adjusted when a deviation of the pixel measurements 6 exceeds a predetermined lower limit in the measurement sequence the data processing device 9 proceeds according to the structural diagram shown simplified in FIG. 4 (Nassi-Shneiderman—diagram).

After the input, marked 14, of the pixel measurements 6, by which a crude data stream 12 of crude IR-images 3, shown for example in FIG. 5, is provided with pixel measurements 6, a loop 15 is performed over all pixels and all pixel measurements 6 of a measurement sequence of the crude data stream 12.

In this loop 15, first a calculation 16 of the difference is performed between successive pixel measurements 6 of the measurement sequence.

Subsequently it is checked in an inquiry 17 if the calculated difference of the pixel measurements 6 exceeds a predetermined lower limit as the threshold.

In the alternative “yes” 18, in which the lower limit is exceeded, a new calculation 19 of the pixel-background value 8 is performed for the presently discussed pixel. Here, a temporarily lagging means is determined for the pixel via the pixel measurements 6 contained in the crude data stream 12. The changed pixel-background value 8 is then saved via a writing process 13 in the storage device 7.

This way, an updated allocation of the pixel results with pixel-background values 8 according to FIG. 6.

In the alternative “no” 20, in which the lower limit is not exceeded, the pixel-background value 8 is not changed in the storage device 7.

Subsequently, in a calculation 21 the perhaps updated pixel-background value 8 is subtracted from the pixel measurement 6 of the pixel.

This way, pixel-by-pixel a pixel value 23 develops of the extracted and/or pre-processed IR-image 2 shown in FIG. 7.

The IR-images 2 pre-processed in this manner are fed via an image data stream 22 to the output unit 11 and here put out as an IR-video—data stream.

The thermal imaging camera 1 according to FIGS. 1 and 2 is embodied with a handle 24 to form a hand-held device, in which an energy supply is integrated.

In the thermal imaging camera 1 for extracting IR-images 2 from a crude data stream 12 of crude IR-images 3, in which a compensation 21 of pixel measurements 6 of the crude IR-images 3 occurs pixel-by-pixel with pixel-background values 8, it is provided that a new calculation 19 of the pixel-background value 8 is performed when the deviation of the pixel measurements 6 in the measurement sequence of the crude data stream 12 for the pixels exceeds a lower limit for the deviations.

1. A method for extracting an IR-image (2) from an image sequence of crude IR-images (3), comprising recording the crude IR-images by an IR-sensor arrangement (4), the crude IR-images comprise pixels with pixel measurements (6), storing a pixel-background value (8) for each of the pixels of the crude IR-images (3) and extracting the IR-image (2) from the image sequence of crude IR-images (3) by compensating the pixel-background value (8) pixel-by-pixel with the pixel measurements (6) of at least one crude IR-image (3) of the image sequence, evaluating a measurement sequence of the pixel measurements (6) of the pixels in the image sequence of the crude IR-images (3) for at least one pixel and changing the pixel-background value (8) stored for said pixel when a deviation of the pixel measurements (6) in the measurement sequence exceeds or does not fall below a predetermined lower limit.

2. The method according to claim 1, further comprising calculating the pixel-background value (8) of a pixel from the measurement sequence of the pixel.

3. The method according to claim 2, wherein only such pixel measurements (6) of the measurement sequence are considered for the calculation of the pixel-background value (8), if their deviations and/or a difference from a previous pixel measurement (6) of the measurement sequence, exceed or do not fall below a predetermined lower limit.

4. The method according to claim 1, wherein for the calculation of the pixel-background value (8) pixel measurements (6) are not considered, if their deviation and/or a difference from a respectively previous pixel measurement (6) of the measurement sequence, exceeds or does not fall below a predetermined upper limit.

5. The method according to claim 1, wherein an overall average of the pixel values (6) of all of the pixels is considered for calculation of the pixel-background value (8).

6. The method according to claim 1, wherein for the calculation of the pixel-background value (8) an average is calculated from the pixel measurements (6) of the measurement sequence as an arithmetic, weighted, or dragging average or an expected value.

7. The method according to claim 1, wherein for the calculation of the pixel-background value (8) at least one of an upper limit or a lower limit is determined for the pixel measurements (6) of the measurement sequence.

8. The method according to claim 1, wherein an initial value is saved for each of the pixel background values (8).

9. The method according to claim 1, wherein for the calculation of the pixel-background value (8) at least one pixel measurement (6) adjacent to the pixel is considered and is compensated with its allocated pixel-background value (8).

10. The method according to claim 1, wherein for the calculation of the pixel-background value (8) of a pixel, the pixel measurements (6) of the pixels adjacent in a vertical direction and in a horizontal direction are considered with different weights that are compensated with their allocated pixel-background values (8).

11. The method according to claim 1, wherein a movement of image contents within an image sequence is detected by a local motion detector, with at least one of a direction or a speed of the motion being considered in the calculation of the pixel-background value (8), with the motion detection being executed with at least one of an acceleration sensor, the IR-sensor arrangement (4) or an element (5) arranged in the radiation path of the IR-sensor arrangement (4) being moved when the measurement sequences of the pixels show insufficient variations.

12. A thermal imaging camera (1) comprising an IR-sensor arrangement (4), which is embodied to record crude IR-images (3), and which comprises an output unit (11), embodied to release IR-images (2) extracted from the recorded crude IR-images (3), and a data processing unit (9) that receives data from the crude IR-images, which comprise pixels with pixel measurements (6), stores a pixel-background value (8) for each of the pixels of the crude IR-images (3) and extracts the IR-image (2) from the image sequence of crude IR-images (3) by compensating the pixel-background value (8) pixel-by-pixel with the pixel measurements (6) of at least one crude IR-image (3) of the image sequence, and evaluates a measurement sequence of the pixel measurements (6) of the pixels in the image sequence of the crude IR-images (3) for at least one pixel and changes the pixel-background value (8) stored for said pixel when a deviation of the pixel measurements (6) in the measurement sequence exceeds or does not fall below a predetermined lower limit.
